(19) United States
(12) Patent Application Publication
(10) Pub. No.: US 2019/0326775 A1
(43) Pub. Date: Oct. 24, 2019

(54) Outdoor Parasol with Plug-in Power Supply Device

(71) Applicants: Ningbo Oriental Prosperity Photoelectric Technolog, Ningbo (CN); ATLeisure LLC, Atlanta, GA (US)

(72) Inventor: Zhou Xinyan, Ningbo (CN)

(73) Assignees: Ningbo Oriental Prosperity Photoelectric Technology Co.,Ltd, Ningbo (CN); ATLeisure LLC, Atlanta, GA (US)

(21) Appl. No.: 15/960,794

(22) Filed: Apr. 24, 2018

(51) Int. Cl. H02J 7/35; H02J 7/00; H02S 30/20; H02S 40/38; E04H 15/28; E04H 15/02; E04H 15/10

(52) U.S. Cl. CPC H02J 7/355; H02J 7/0052; H02S 30/20; H02J 2007/0062; E04H 15/28; E04H 15/02; E04H 15/10; H02S 40/38

(57) ABSTRACT

A plug-in power supply device for outdoor leisure products, such as parasols, which feature a lifting handle casing. A handle is set on the casing and the lifting handle casing is installed at the middle section of the solar parasol's pole; on the top of the pole a canopy and an exposed solar panel outside the canopy are installed. Within the pole, an electric wire is set, one end of which is connected to the solar panel and the other end to the circuit board in the lifting handle casing. On one side of the lifting handle casing a recess is provided for a portable and detachable power unit to be snapped in. On the outer side of the portable power unit, a USB charger and outlet is provided. The portable power unit can be either attached to or detached from the parasol when in use. A cell phone can be charged when connected with the portable power unit through the USB charger and outlet.

### TECHNICAL FIELD

The disclosure involves an outdoor parasol with a power supply device; to be specific, it is a plug-in power supply device for solar parasols and other outdoor leisure products.

### BACKGROUND

Umbrellas are a kind of tool to provide a shady and cool environment or keep out the rain or snow. Generally, material to make umbrellas includes malleable fabric, a rigid material to make the frame, and a raising and lowering means, such as a cable or rope. To use umbrellas, people will raise and lower them by hand. Though the main purpose of umbrellas initially is to block off sunlight, now they are often used as rain gear to protect people from the rain. When solar-powered lights added to the parasol, it becomes even more comfortable and convenient for people to use in the night or evening.

A lifting device is set at the middle section of the pole for convenient lifting purposes by means of a crank handle. While current technology can only lift and lower the parasol, further improvements are obtainable.

### SUMMARY

In view of the above-mentioned existing technology, the present device aims to provide a plug-in power supply device with a detachable and portable power unit for outdoor leisure products.

Technical solutions are as follows: the plug-in power supply device for outdoor leisure products includes a lifting handle casing; a handle is set on the casing and the described lifting handle casing is installed at the middle section of the solar parasol's pole; on the top of this pole, a canopy and an exposed solar panel outside the canopy are set; within the described pole, an electric wire is installed, one end of which is connected to the solar panel and the other end to a circuit board in the lifting handle casing; on one side of the described lifting handle casing, a portable and detachable power unit is installed in a recess, which is formed for the portable power unit to be snapped in; on the outer side of the described portable power unit, a USB charger and outlet is provided.

Further, the rope connected to the handle is set in the described pole for raising and lowering the canopy. LED lights are distributed on ribs at the bottom of the described canopy and are connected to the solar panel to provide lighting. In addition, a protective cover is set outside the described USB charger and outlet.

Advantages of using this kind of plug-in power supply device for outdoor leisure products provided by this device are: on one side of the lifting handle casing a recess is formed for the portable power unit to be snapped in; on the outer side of the portable power unit, a USB charger and outlet is set. Therefore, when the product is used, the portable power unit can be charged with the solar panel. Since the portable power unit is detachable, the fully-charged power unit can be either attached to or removed from the parasol when in use. A cell phone can be charged when connected with the portable power unit through the USB charger and outlet, which is convenient for use.

### BRIEF DESCRIPTION OF THE DRAWINGS

FIG. 1 is a schematic diagram of the overall structure of the solar parasol;

FIG. 2 is a cross-section view of the lifting device showing the portable power unit installed; and

FIG. 3 is an exploded view of the lifting device and portable power unit.

### DETAILED DESCRIPTION

To understand the technical solutions of the device more intuitively and completely, its nonrestrictive features will be illustrated as follows, along with the attached diagrams:

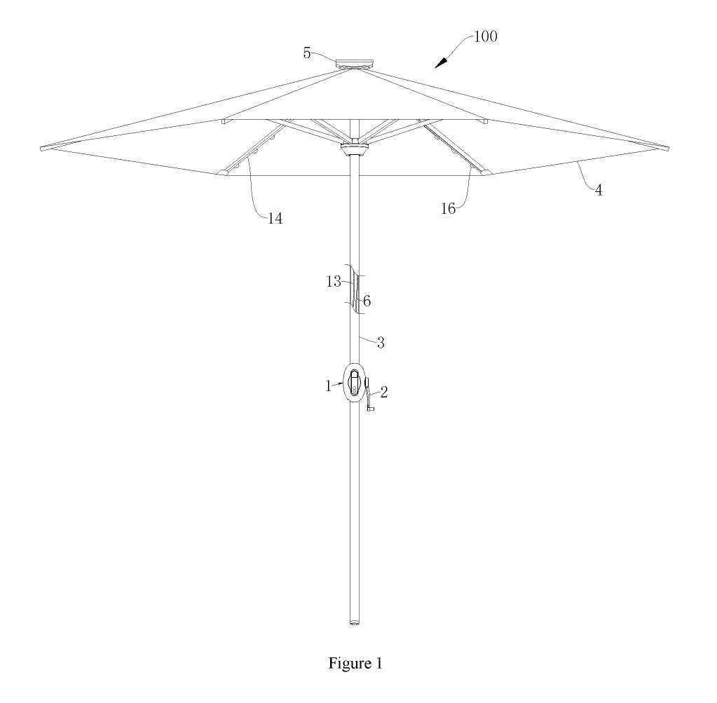

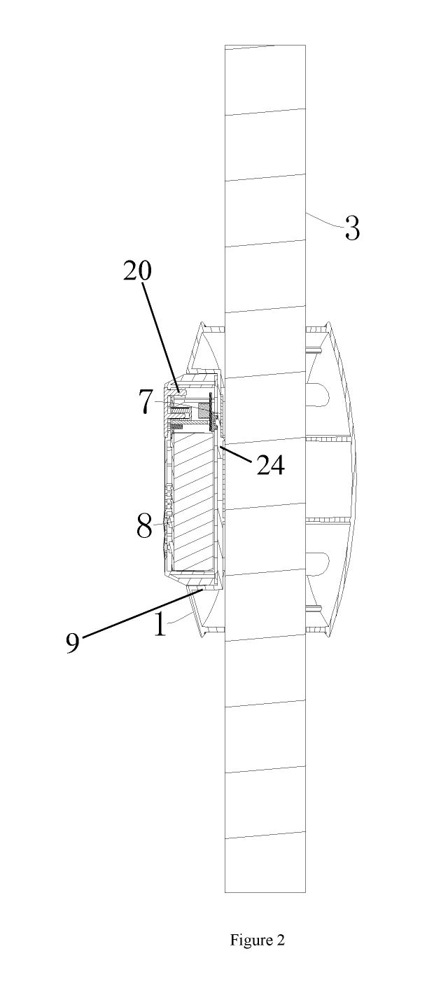

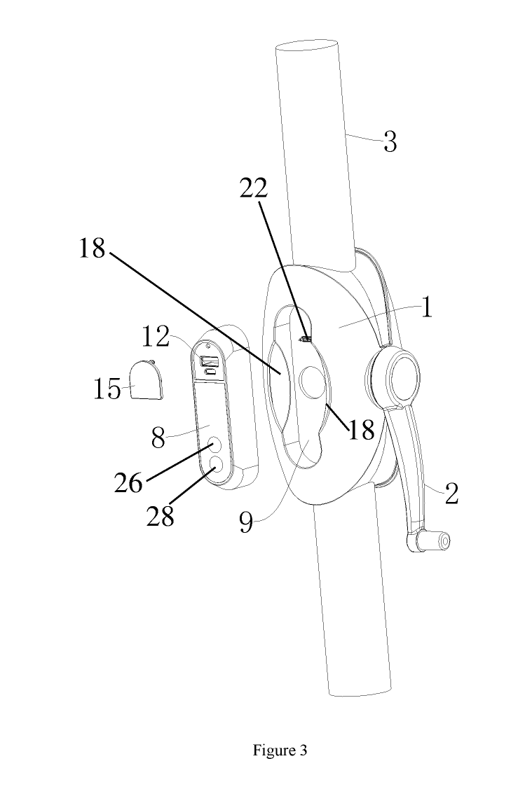

As shown in FIGS. 1-3, a plug-in power supply device for outdoor leisure products is disclosed, which includes a lifting handle casing 1. A handle 2 is set on the casing 1 and the lifting handle casing 1 is installed substantially in the middle of the solar parasol 100's pole 3. On the top of this pole 3, a canopy 4 and an exposed solar panel 5 outside the canopy 4 are set. In the pole 3, an electric wire 6 is set, one end of which is connected to the solar panel 5 and the other end to the circuit board 7 in the lifting handle casing 1. On one side of the lifting handle casing 1, a portable and detachable power unit 8 is installed, in a recess 9, designed for the portable power unit 8 to be snapped in. On the outer side of the portable power unit 8, a USB charger and outlet 12 is set.

The rope connected to the handle 2 is set in the pole 3, and lifting of the parasol is controlled by stretching and shortening the rope

LED lights 16 are distributed on ribs 14 at the bottom of the canopy 4, which can function as lighting.

A protective cover 15 is set outside the USB charger and outlet 12, which can prevent water and dust intrusion.

A recess 9 is formed in the casing for receiving the portable power unit 8. The recess is flared outwardly on each side 18 for the user to be able to manipulate the portable power unit when inserting and removing the unit from the recess. The portable power unit is secured with a flexible clip 20 at the upper edge thereof. A connector plug 2 extends outwardly from the back of the portable power unit and connects the circuit board 7 to terminal 24 which is connected to the electric wire and power supply. Switches 26 and 28 are provided to operate the LED lights.

Therefore, when the portable power unit 8 is secured in the recess, it can be charged by the solar panel 5. Since the portable power unit is detachable, the fully-charged power unit can be either attached to or detached from the parasol when in use. A cell phone can be charged when connected with the portable power unit through the USB charger and outlet, which is convenient for use.

The portable power unit 8 can be removed and connected to a universal cell phone charger for charging, and also used as a mobile power bank to charge cell phones, laptop computers and other devices.

The portable power unit 8, being installed on the lifting handle casing 1, is a convenient application of the device. The power unit 8 can also be installed on other positions of parasols and can supply power for LED lights. Installation location may be selected based on the specific environment for use.

Of course, the above is only one embodiment of this disclosure; the scope of the claims is not limited to this model. All simple decorations or equivalent structure changes by using the specifications and the schematic contents of this disclosure shall be included in the patent protection scope.

1. A solar-powered parasol comprising a support pole with a solar panel mounted thereon, a canopy, and a plurality of ribs for supporting said canopy, the pole having a lifting mechanism therein for raising and lowering said ribs with a controlling crank operatively connected therewith, said crank being housed in a casing, said casing having a recess formed therein and receiving a portable power unit, said pole further including a solar panel with a power cord connected thereto, said power cord terminating at said recess for charging said power unit.

2. A solar-powered parasol as defined in claim 1 in which said power unit is releasably secured in said recess.

3. A solar-powered parasol as defined in claim 2 in which said power unit includes a USB charging port and a USB charger outlet.

4. A solar-powered parasol as defined in claim 1 in which said power unit includes a USB charging port and a USB charger outlet, and at least one light fixture is operatively connected to said solar panel and said power unit.

5. A solar-powered parasol as defined in claim 1 in which said power unit includes a retaining clip for retaining said power unit in said recess.

6. A solar-powered parasol as defined in claim 5 in which said recess includes a circuit board for receiving electrical power from said solar panel and transferring the power to said power unit for charging said power unit.

7. A solar-powered parasol as defined in claim 6 in which said power unit is detachable from said recess and serves as a mobile power bank.

8. A solar-powered parasol as defined in claim 1 in which said recess includes a circuit board for receiving electrical power from said solar panel and transferring the power to said power unit for charging said power unit.

9. A solar-powered parasol as defined in claim 8 in which said power unit is detachable from said recess and serves as a mobile power bank.

10. A solar-powered parasol as defined in claim 1 in which said power unit is detachable from said casing for serving as a mobile power bank.

11. A solar powered parasol comprising an elongated support pole, a canopy, and a plurality of extendable ribs for supporting said canopy, a cranking mechanism disposed on said pole and operable to extend and retract said ribs, a casing for housing said cranking mechanism with a recess formed therein, a portable power unit releasably secured in said recess and having a chargeable battery therein, a solar panel mounted on said pole and being electrically connected to said portable power unit for charging said battery.

12. A solar-powered parasol as defined in claim 11 in which said power unit includes a USB charging port and a USB charger outlet.

13. A solar-powered parasol as defined in claim 11 in which said power unit includes a USB charging port and a USB charger outlet, and at least one light fixture is operatively connected to said solar panel and said power unit.

14. A solar-powered parasol as defined in claim 11 in which said power unit includes a retaining clip for retaining said power unit in said recess.

15. A solar-powered parasol as defined in claim 11 in which said recess includes a circuit board for receiving electrical power from said solar panel and transferring the power to said power unit for charging said power unit.

16. A solar-powered parasol as defined in claim 11 in which said power unit is detachable from said casing for serving as a mobile power bank.
